(19) United States
(12) Patent Application Publication
(10) Pub. No.: US 2015/0142463 A1
(43) Pub. Date: May 21, 2015

(54) Performance of Pharmacy Search Based on a Prescription Card

(71) Applicant: International Medical Records Systems, LLC, Dallas, TX (US)

(72) Inventor: Javier Vinals, Madrid (ES)

(73) Assignee: INTERNATIONAL MEDICAL RECORDS SYSTEMS, LLC, Dallas, TX (US)

(21) Appl. No.: 14/541,842

(22) Filed: Nov. 14, 2014

Related U.S. Application Data
(60) Provisional application No. 61/905,331, filed on Nov. 18, 2013.

(51) Int. Cl. G06Q 30/06; H04W 64/00; G06Q 50/22

(52) U.S. Cl. CPC G06Q 30/0627; G06Q 50/22; H04W 64/00
USPC 705/2

(57) ABSTRACT

According to one embodiment, a system includes a memory and one or more processors communicatively coupled to the memory. The processors are operable to receive, from a user, a selection associated with a search for a pharmacy. The processors are further operable to receive an indication of a location of the user. The processors are further operable to, based at least on the selection and the indication of the location, generate a list of a plurality of potential pharmacies that are each associated with a prescription card of the user. The processors are further operable to communicate, for display to the user, the list.

### CROSS REFERENCE TO RELATED INFORMATION

This application claims the benefit of U.S. Provisional Patent Application No. 61/905,331, filed Nov. 18, 2013, the contents of which are hereby incorporated herein in its entirety.

### TECHNICAL FIELD

The present disclosure is directed to the field of medicine and more specifically to a performance of a pharmacy search based on a prescription card.

### BACKGROUND OF THE INVENTION

Traditionally, when an individual wants to purchase prescription products using a prescription card, the individual will visit the pharmacy that the individual typically uses (or the first pharmacy that the individual sees) and will provide the prescription card to the pharmacy prior to paying for the prescription products. Such traditional methods, however, may be deficient.

One frustration faced by consumers is finding a pharmacy that accepts their insurance. The insurance company often has a list of providers on their website, or the consumer can call a pharmacy and check what insurance they accept but this can be time consuming. Different pharmacies also have different prices. A consumer can call multiple pharmacies, provide their insurance, get the insurance approved and then check the cost of a prescription but this is time consuming. In some situations a consumer will have multiple insurance cards or discount cards. It can therefore become more time consuming finding pricing information for each card for multiple pharmacies to compare costs. Discounts are available as well, either by coupon, or code or some other method. Consumers would like to be able to use these discounts and combine them with their insurance cards or discount cards. But it can be complicated to combine these and check prices at multiple pharmacies.

A further problem for consumers arises with communication between the consumer and their doctor, the consumer and their pharmacy, and the doctor and the pharmacy. For example a consumer may be ill and needs to refill a prescription or get a new one. If the customer calls their doctor to request a prescription or refill they may have to leave a message. Then a nurse may need to call the patient to discuss the issue and only after that will the nurse call the pharmacy to order a prescription. This can take a day or more, causing delay and causing the patient to become sicker. It would be nice to have a tool that facilitates communication between all these parties.

There is also a lack of portability of information in the current insurance and pharmacy system. For example, when a doctor's office calls in a prescription to a pharmacy for a patient then that prescription can be stuck at that pharmacy. The consumer can often call the pharmacy to transfer the prescription to another pharmacy but this is time consuming. Similarly, when a consumer's insurance changes, or the consumer gets a new discount card or code of some kind, it is time consuming to call all of the consumer's doctors, pharmacies, and other providers to change that information. Also, if a consumer forgets their insurance card when they go to a doctor or pharmacy it can be frustrating.

Another problem that can arise is that a consumer may have multiple doctors for several different maladies. And the consumer may use several different pharmacies. One particular pharmacy may have a specialty, such as compounding, while another pharmacy has better prices on a given medicine. A consumer's multiple medical service providers can cause a problem if there are complications between medicines or treatments. Some drug interactions can be harmful to the patient. Usually a doctor or pharmacist will keep track of a patient's prescriptions and any dangerous interactions. But when a consumer uses multiple doctors and pharmacies the medical providers may not have a complete medical history to review. It would therefore be helpful to have a tool to help facilitate communication or awareness of a patient's prescriptions and drug history and possible dangerous interactions.

Another problem consumers sometimes face is when a pharmacy is out of a drug. A consumer may take a prescription to a pharmacy, but then find out that it's out of stock and must be ordered. This can be time consuming and frustrating especially when a consumer is sick. It would therefore be helpful to have a tool that quickly lets a consumer know what pharmacies have a specific drug in stock.

It would also be helpful to have a tool that allows a customer to quickly get prices quotes from multiple pharmacies for a given medication. It would also be helpful to have a tool that can compare the distance of multiple pharmacies to a customer such that a customer can compare cost of a medication and driving distance to multiple pharmacies.

It would further be helpful to have a tool that helps a customer to check-in when entering a doctor's office or pharmacy. Lines at these locations can be slow and a quicker check-in service would be helpful.

### BRIEF SUMMARY OF THE INVENTION

An embodiment of the invention comprises a memory and one or more processors. The processors are coupled to the memory and are operable to receive a selection associated with a search for a pharmacy from a user and an indication of a location of a user. Based at least on the selection and the indication of the location, the processors can generate a list of a plurality of potential pharmacies that are each associated with a prescription card of the user and communicate the list to the user.

A further embodiment of the invention is a system for connecting users and pharmacies comprising a network connection, a microprocessor, a memory, and a database. The database is operable to store information related to a pharmacy and insurance information of a user. The database can communicate the insurance information to a pharmacy and check the pharmacy for availability of a given medicine and get pricing information based on the user's insurance. The database can then communicate this information for display to a user.

A further embodiment of the invention is a method for connecting a user and a pharmacy. The method comprises storing pharmacy related data on one or more databases, receiving from a user a selection associated with a search for a pharmacy, receiving an indication of the location of a user, generating a list, based at least on the selection and the indication of the location, of a plurality of potential pharmacies that are each associated with a prescription card of the user, and communicating the list for display to the user.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawings, in which:

FIG. 1 is a diagram of an embodiment of the invention that performs a pharmacy search based on a prescription card according to one embodiment of the disclosure;

FIGS. 2A-2C are diagrams of the user interface example displays according to one embodiment of the present disclosure;

FIGS. 3A-3B are diagrams of the user interface example displays according to one embodiment of the present disclosure;

FIGS. 4A-4C are diagrams of the user interface example displays according to one embodiment of the present disclosure; and

FIG. 5 is a diagram of an example display according to one embodiment of the present disclosure.

FIG. 6 is a flow-chart diagram of an embodiment of the process of a prescription search under the invention.

FIG. 7 is a flow-chart diagram of an embodiment of the check-in process under the invention.

FIG. 8 is a flow-chart diagram of an embodiment of the check-in process under the invention.

FIG. 9 is a flow-chart diagram of an embodiment of the process for a pharmacy search under the invention.

FIG. 10 is a flow-chart diagram of an embodiment of the process for analyzing drug interactions under the invention.

### DETAILED DESCRIPTION OF THE INVENTION

Embodiments of the present invention can provide a consumer with a graphical user interface for searching for a pharmacy or another medical service provider while at the same time storing prescriptions or information about the consumer such that the consumer can take this information anywhere and also search for pharmacies according to a variety of consumer chosen information.

According to one embodiment, a system includes a memory and one or more processors communicatively coupled to the memory. The processors are operable to receive, from a user, a selection associated with a search for a pharmacy. The processors are further operable to receive an indication of a location of the user. The processors are further operable to, based at least on the selection and the indication of the location, generate a list of a plurality of potential pharmacies that are each associated with a prescription card of the user. The processors are further operable to communicate, for display to the user, the list.

Certain embodiments of the disclosure may provide one or more technical advantages. For example, by generating a list of a plurality of potential pharmacies that are each associated with a prescription card of the user, the user may be able to search for and view a pharmacy that may accept the user's prescription card. As another example, by communicating a graphical user interface that includes a code associated with the prescription card of the user, the user may not have to actually bring the prescription card to the pharmacy.

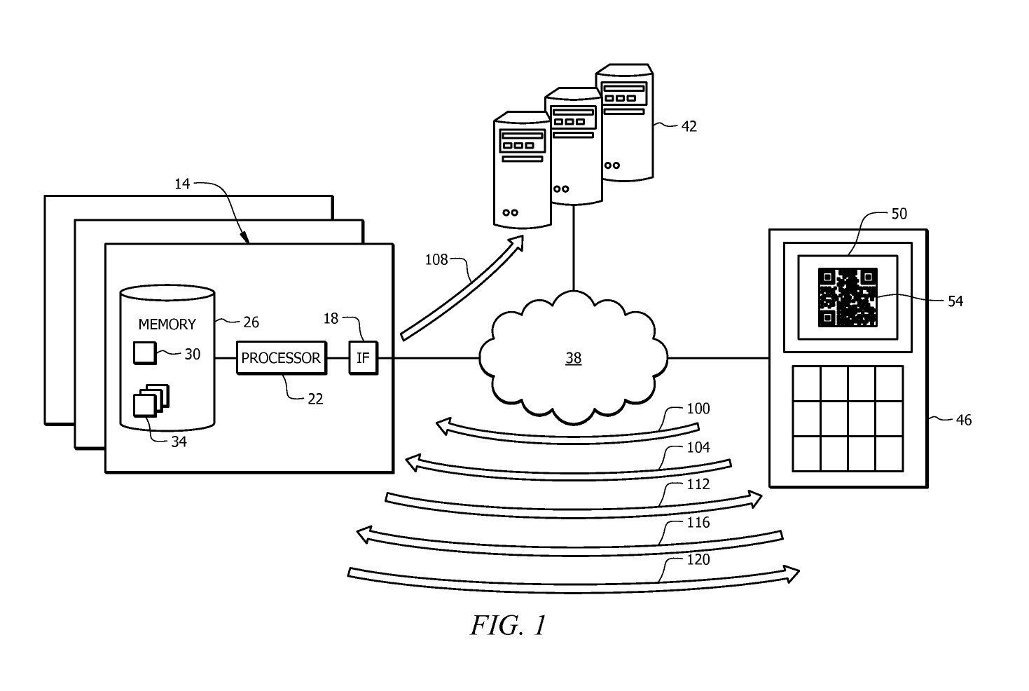

Certain embodiments of the disclosure may include none, some, or all of the above technical advantages. One or more other technical advantages may be readily apparent to one skilled in the art from the figures, descriptions, and claims included herein. Embodiments of the present disclosure are best understood by referring to FIGS. 1-10 of the drawings.

FIG. 1 illustrates a system 10 that performs a pharmacy search based on a prescription card according to one embodiment of the disclosure. As illustrated, system 10 includes a device 14 that receives a selection associated with a search for a pharmacy from mobile device 46. Based on this selection, device 14 may generate a list of one or more potential pharmacies that are each associated with a prescription card of a user of mobile device 46. Device 14 may then communicate, for display to the user on mobile device 46, the list of potential pharmacies. As such, system 10 may allow a user to search for a pharmacy that may accept the user's prescription card. Furthermore, device 14 may further communicate a graphical user interface that includes a code associated with the prescription card of the user. As such, the user may not have to actually bring the prescription card to the pharmacy.

A pharmacy may refer to an entity or part of an entity in which prescription products are prepared, sold, and/or given out. A prescription product may refer to any type of drug, medicine, and/or health-related product that may be prepared, sold, and/or given out by a pharmacy. For example, a prescription product may include a drug that was prescribed to an individual by a doctor. As another example, a prescription product may be a drug that a doctor recommended to the individual, but which may not require a prescription in order to purchase or receive. A prescription card may refer to any item that may cause a pharmacy to provide a discount on one or more prescription products purchased (or obtained) by an individual. As an example, a prescription card may be given to an individual in order to assist the individual in paying for (or otherwise obtaining) the prescription. A prescription card may provide any type of discount on any type of prescription product. For example, the prescription card may provide a 10% discount, a 20% discount, a $2.00 discount, a $20.00 discount, or any other type of discount. A prescription card provider (e.g., an entity that creates and/or distributes the prescription card) may negotiate with pharmacies in order to have the pharmacies provide one or more prescription products at a discounted price. Such negotiations may cause one pharmacy to provide a better discount for a prescription product than another pharmacy. As such, a user may be able to purchase (or otherwise obtain) the prescription product for a lower price at one pharmacy than at another pharmacy.

Traditionally, when an individual wants to purchase prescription products using a prescription card, the individual will visit the pharmacy that the individual typically uses (or the first pharmacy that the individual sees) and will provide the prescription card to the pharmacy prior to paying for the prescription products. Such traditional methods, however, may be deficient. For example, the pharmacy that the individual typically uses may not be the closest pharmacy to the individual and/or the pharmacy may not provide the highest overall discount (using the prescription card) or even the lowest total cost (using the prescription card) for the prescription products the individual is purchasing. Furthermore, in these traditional methods, the individual may need to provide the prescription card to the pharmacy when paying for the prescription products. Unfortunately, the individual may not have the prescription card on them when they go to the pharmacy.

One or more of these deficiencies may be addressed by system 10 of FIG. 1. As illustrated, system 10 includes device 14. Device 14 may represent any components that perform a pharmacy search based on a prescription card, and may be implemented using any suitable combination of hardware, firmware, and software. Device 14 may include a network server, any remote server, a mainframe, a host computer, a workstation, a web space server, a personal computer, a file server, or any other device operable to perform a pharmacy search based on a prescription card. The functions of device 14 may be performed by any combination of one or more servers or other components at one or more locations. If the module is a server, the server may be a private server, and the server may be a virtual or physical server. The server may include one or more servers at the same or remote locations. Also, device 14 may include any component that functions as a server. Although FIG. 1 illustrates system 10 as only including one device 14, system 10 may include any suitable number of devices 14. Furthermore, each of these devices 14 may operate together as a single information system (e.g., a cloud-based management system).

As illustrated, device 14 includes a network interface 18, a processor 22, and a memory 26. Network interface 18 may represent any device operable to receive information from network 38, transmit information through network 38, perform processing of information, communicate to other devices, or any combination of the preceding, and may be implemented using any suitable combination of hardware, firmware, and software. For example, network interface 18 may receive information from a prescription card database 42. As another example, network interface 18 may communicate a list of potential pharmacies for display on a mobile device 46. Network interface 18 may represent any port or connection, real or virtual, including any suitable hardware and/or software, including protocol conversion and data processing capabilities, to communicate through a local area network (LAN), a metropolitan area network (MAN), a wide area network (WAN), a local, regional, or global communication or computer network, such as the Internet, a wireline or wireless network, an enterprise intranet, or other communication system (or a combination of these systems) that allows device 14 to exchange information with network 38, prescription card database 42, mobile device 46, or other components of system 10.

Processor 22 communicatively couples to network interface 18 and memory 26, and controls the operation and administration of device 14 by processing information received from network interface 18 and memory 26. For example, processor 22 executes device application 30 to control the operation of device 14. Processor 22 may be a programmable logic device, a microcontroller, a microprocessor, any processing device, or any combination of the preceding.

Memory 26 stores, either permanently or temporarily, data, operational software, or other information for processor 22. Memory 26 includes any one or a combination of volatile or non-volatile local or remote devices suitable for storing information. For example, memory 26 may include random access memory (RAM), read only memory (ROM), magnetic storage devices, optical storage devices, databases (such as a Structured Query Language (SQL) database), or any other information storage device or a combination of these devices. While illustrated as including particular modules, memory 26 may include any information for use in the operation of device 14.

As illustrated, memory 26 includes device application 30 and one or more prescription card accounts 34. Device application 30 may represent any suitable set of instructions, logic, or code embodied in a computer readable storage medium and operable to facilitate the operation of device 14.

Prescription card accounts 34 may represent records of prescription card accounts for one or more users. For example, a first prescription card account 34 may represent an account associated with a prescription card of a first user (e.g., user A) while a second prescription card account 34 may represent an account associated with a prescription card for a second user (e.g., user B). Memory 26 may store any number of prescription card accounts 34. For example, memory 26 may store prescription card account 34 for one user, ten users, or any other number of users.

A prescription card account 34 may associate a particular user (e.g., user A) with a particular prescription card. For example, when a user receives a prescription card (e.g., from a doctor), the prescription card may have an account code included on the prescription card. The user may register that code with device 14 (using, for example, mobile device 46) in order associate the code with the user. Such a registration may occur by the user downloading a prescription card application (such as prescription card application 50). By registering the code on the prescription card with device 14, device 14 may have access to the type of prescription card, the type of prescription products that are covered by the prescription card, any other information associated with the prescription card, or any combination of the preceding. Furthermore, by registering the code with device 14, device 14 may be able to search for one or more potential pharmacies using the information associated with the prescription card, and may further be able to provide a code associated with the prescription card to the user when the user is purchasing prescription products.

Network 38 may represent any network operable to facilitate communication between the components of system 10, such as device 14, prescription card database 42, and mobile device 46. Network 38 may include any interconnecting system capable of transmitting audio, video, signals, data, messages, or any combination of the preceding. Network 38 may include all or a portion of a public switched telephone network (PSTN), a public or private data network, a LAN, a MAN, a WAN, a local, regional, or global communication or computer network, such as the Internet, a wireline or wireless network, an enterprise intranet, or any other communication link, including combinations thereof, operable to facilitate communication between the components.

Prescription card database 42 represents any components that may store information associated with a prescription card. For example, prescription card database 42 may store information associated with pharmacies that accept the prescription card (or otherwise provide a discount based on the prescription card), information associated with a discount provided by a pharmacy based on the prescription card, information associated with a price (or total cost) charged by the pharmacy for a particular prescription product using the prescription card, any other suitable information associated with the prescription card, or any combination of the preceding. The prescription card database 42 may be managed by a prescription card provider or any other entity.

Prescription card database 42 may include a network server, any remote server, a mainframe, a host computer, a workstation, a web space server, a personal computer, a file server, a virtual device, or any other device that may store information associated with a prescription card. The functions of prescription card database 42 may be performed by any combination of one or more servers or other components at one or more locations. In the embodiment where the module is a server, the server may be a private server, and the server may be a virtual or physical server. The server may include one or more servers at the same or remote locations. In addition to storing information associated with a prescription card, prescription card database 42 may allow the stored information to be searched and/or or viewed(e.g., viewed by a user using mobile device 46). For example, device 14 may access the information stored in prescription card database 42 in order to search for potential pharmacies that may correspond to a selection received from a user (using mobile device 46). Based on such a search, device 14 may generate a list of the potential pharmacies, and may provide that list for display to the user.

Although FIG. 1 illustrates system 10 as only including one prescription card database 42, system 10 may include any suitable number of prescription card databases 42. For example, system 10 may include more than one prescription card database 42. Furthermore, each of these prescription card databases 42 may operate together as a single information system (e.g., a cloud-based management system).

Mobile device 46 represents any suitable components that may communicate a selection associated with a search for a pharmacy to device 14. Mobile device 46 may include a personal computer, a workstation, a laptop, a wireless or cellular telephone, a Smartphone, an electronic notebook, a personal digital assistant, or any other device(wireless, wireline, or otherwise) capable of receiving, processing, storing, and/or communicating information with other components of system 10. A user may utilize mobile device 46 in order to retrieve a list of potential pharmacies that the user may go to in order to purchase prescription products using a prescription card. Furthermore, the user may utilize mobile device 46 in order to purchase the prescription products.

Mobile device 46 executes a prescription card application 50. Prescription card application 50 represents any suitable software or logic for receiving, generating, and/or communicating information to other components of system 10 in order for the user to retrieve a list of potential pharmacies and/or in order to allow the user to purchase (or otherwise obtain) one or more prescription products using a prescription card. Prescription card application 50 may be downloaded to mobile device 46 from, for example, device 14.

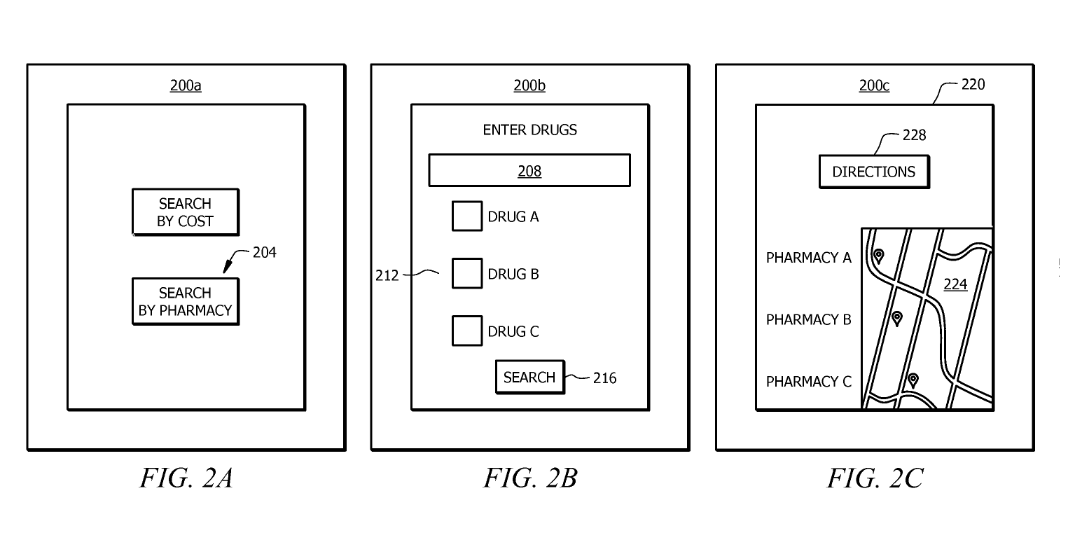

Mobile device 46 may display a graphical user interface 54 in order to allow a user to display the information received from device 14, request information from device 14, and/or provide selections to device 14. In particular embodiments, graphical user interface 54 may be displayed on mobile device 46 as a part of prescription card application 50. As an example, the user may open (or otherwise execute) prescription card application 50 in order to view graphical user interface 54. Examples of graphical user interface 54 are discussed further below with regard to FIGS. 2-5.

Although FIG. 1 illustrates system 10 as including only one mobile device 46, system 10 may include any other number of mobile devices 46. For example, system 10 may include more than one mobile device 46. Furthermore, although FIG. 1 illustrates device 14, prescription card database 42, and mobile device 46 as separate components, two or more of the device 14, prescription card database 42, and mobile device 46 may be the same component. For example, device 14 and prescription card database 42 may be the same component. In such an example, the same device may both receive a selection associated with a search for a pharmacy from a user and also store information associated with a prescription card. As another example, device 14 and mobile device 46 may be the same device. In such an example, a user may view a list of potential pharmacies at the same device that generates the list of potential pharmacies.

In an example of operations of system 10, in order to retrieve a list of potential pharmacies for the user to go to in order to purchase (or otherwise obtain) one or more prescription products, a user may transmit a selection 100 to device 14. Selection 100 may include any selection associated with a search for a pharmacy. For example, the selection may include a selection of one or more prescription products. In such an example, the user may utilize mobile device 46 and prescription card application 50 to input identifying information associated with a prescription product, such as the name of a painkiller. This selection of the painkiller may be transmitted as selection 100 to device 14. Further examples of selection 100 are discussed further below with regard to FIGS. 2-5.

In addition to selection 100, location indication 104 may also be transmitted to device 14. Location indication 104 may include any indication of a location of the user. The location of the user may refer to the location of the user or the location of the mobile device 46 being used by the user. The location of the user may be determined in any suitable manner. For example, mobile device 46 may be able to determine the location of the user using Global Positioning System (GPS), Bluetooth, any other manner of determining location, or any combination of the preceding. Once the location of the user is determined, location indication 104 may be transmitted to device 14. Location indication 104 may be transmitted automatically by mobile device and/or prescription card application 50 (e.g., while prescription card application 50 is being executed on mobile device 46, prescription card application 50 may automatically transmit location indication 104 to device 14), or location indication 104 may be transmitted based on an entry by the user (e.g., the user may input their location, such as by inputting a zip code or street address of their location, for transmission to device 14 using indication 104).

Following the receipt of selection 100 and indication 104, device 14 may perform a search 108 of prescription card databases 42 in order to generate a list of potential pharmacies for communication to the user. Search 108 may be performed using any suitable information. For example, search 108 may be performed using selection 100 (e.g., a selection of a plurality of prescription products), location indication 104, prescription card accounts 34, any other information, or any combination of the preceding. As an example, device 14 may utilize prescription card account 34 in order to determine which pharmacies are associated with the prescription card in the user's prescription card account 34. Furthermore, device 14 may also (or alternatively) utilize selection 100 in order to generate a list of potential pharmacies. In such an example, if the selection 100 provided by the user is for a particular pain killer, device 14 may search for potential pharmacies that sell that painkiller. Furthermore, device 14 may also (or alternatively) utilize location indication 104 in order to search for potential pharmacies. In such an example, device 14 may only search for pharmacies that are located within a particular range (e.g., one mile, two miles, three miles, ten miles, etc.) of the location of the user.

Based on search 108, device 14 may generate a list of potential pharmacies for communication to mobile device 46 as results 112. The list of potential pharmacies may include an order of ranking that is based on selection 100 and/or location indication 104. For example, the list of potential pharmacies may be ranked based on which potential pharmacies are closest to the location of the user, an overall discount provided by each pharmacy, a total cost of the prescription products desired by the user at each pharmacy, any other suitable manner of ranking, or any combination of the preceding.

Results 112 may include any suitable information to be displayed in any suitable format. Furthermore, mobile device 46 may display results 112 on graphical user interface 54. As such, a user of mobile device 46 may be able to view potential pharmacies that the user may go to in order to purchase (or otherwise obtain) prescription products. Example results 112 communicated by device 14 and displayed to the user are discussed below with regard to FIGS. 2-5.

Mobile device 46 may further transmit a second location indication 116 to device 14. Second location indication 116 may be similar to location indication 104, except it may occur at a different time than location indication 104 and/or it may include a different location of the user. As an example, second location indication 116 may indicate that the user is located at one of the potential pharmacies.

Following receipt of second location indication 116, device 14 may transmit code messages 120. Code messages 120 may include a code associated with a prescription card. As a result of receiving code message 120, the user may be able to utilize the code associated with the prescription card in order to purchase (or otherwise obtain) prescription products. Code messages 120 may further (or alternatively) include information associated with prescription products that have been purchased (or otherwise obtained) by the user using the prescription card. As such, the user may be able to view a summary associated with the purchase (or obtainment) of prescription products by the user using the code.

Modifications, additions, or omissions may be made to system 10 without departing from the scope of the invention. For example, although second location indication 116 and code message 120 are described above as occurring after selection 100, location indication 104, search 108, and results 112, second location indication 116 and code message 120 may occur before one or more of selection 100, location indication 104, search 108, and results 112. Furthermore, second location indication 116 and code message 120 may occur without selection 100, location indication 104, search 108, and results 112 occurring. As such, a user does not have to perform a search for potential pharmacies in order to receive code message 120. Additionally, system 10 may include any number of devices 14, networks 38, prescription card databases 42, and/or mobile devices 46. Furthermore, any suitable logic may perform the functions of system 10 and the components within system 10.

FIGS. 2A-2C illustrate example displays 200 according to one embodiment of the present disclosure. Displays 200 may be displayed to a user using a mobile device, such as mobile device 46 of FIG. 1. Display 200a of FIG. 2A may be displayed to a user when the user opens an application associated with display 200a, such as prescription card application 50 of FIG. 1, and/or when a mobile device executes the application associated with display 200a. Display 200b of FIG. 2B and display 200c of FIG. 2C may be displayed to a user following a selection by the user, such as a selection 100 of FIG. 1 associated with a search for a pharmacy.

As illustrated, display 200a includes one or more selection choices 204. Selection choices 204 may allow the user to select a manner in which a user can search for a pharmacy. For example, as is illustrated in display 200, the user can search for a pharmacy by: (1) searching for pharmacy based on a best total cost; or (2) searching for a pharmacy based on information about the pharmacy. The user may select one of selection choices 204 by clicking on (or otherwise selecting) one of the selection choices 204. The selection of one of selection choices 204 by the user may be one example of selection 100 of FIG. 1.

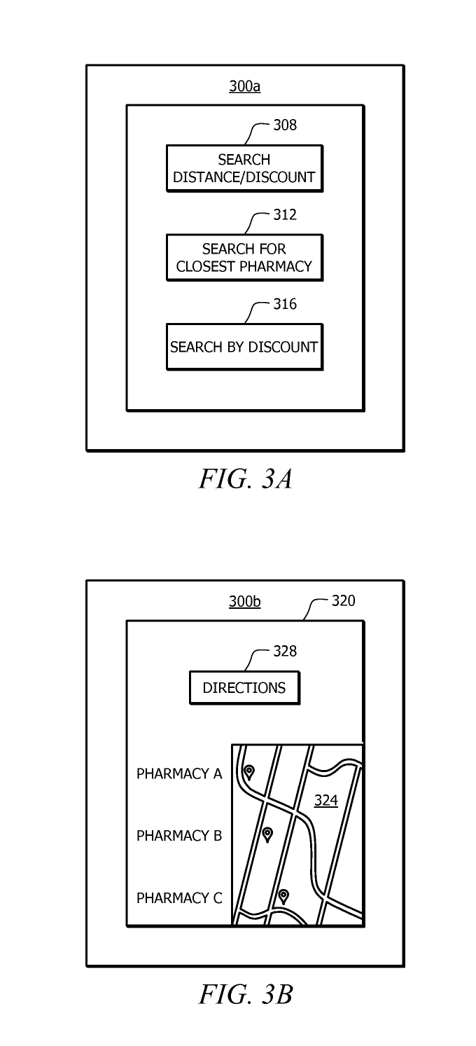

Following the selection by the user to search for a pharmacy based on information about the pharmacy (selection 2 above), the user may receive various options for how to search for a pharmacy based on information about the pharmacy, as is described below with regard to FIGS. 3A-3B. On the other hand, following the selection by the user to search for a pharmacy based on a best total cost (selection 1 above), display 200b of FIG. 2 may be displayed to a user.

As illustrated, display 200b includes an entry section 208 and a prescription products list section 212. Entry section 208 may allow a user to enter one or more prescription products that the user may purchase at a pharmacy. The user may enter the prescription products in any suitable manner. As an example, the user may enter the name of the prescription product, an abbreviation associated with the prescription product, a brand name associated with the prescription product, a product number associated with the prescription product, any other manner of entering a prescription product, or any combination of the preceding.

Following entry of a prescription product in entry section 208, the user may elect to search for the prescription product. The search for the prescription product (which may be performed by device 14, mobile device 46, and/or prescription card application 50) may cause an image of the prescription product and/or a description of the prescription product to be displayed in prescription product list 212. The user may then determine whether the user wants to search for another prescription product to perform a total cost search for. In this manner, the user may search for a total cost for any number of prescription products. For example, the user may search for the total cost of one prescription product, two prescription products, three prescription products, or any other suitable number of prescription products.

Display 200b of FIG. 2 further includes selection button 216 that may allow the user to search for the total cost of one or more prescription products. The total cost for prescription products may refer to the total price charged by a respective pharmacy for each prescription product selected by the user. In particular embodiments, by clicking on (or otherwise selecting) selection button 216, a search may be performed (e.g., by system 10 of FIG. 1) for one or more pharmacies that provide the lowest total cost for each of the prescription products selected by the user. For example, a user may desire to purchase prescription product A and prescription product B at a pharmacy. As such, the user may input prescription product A and prescription product B in prescription list 212 (as is described above). Following selection of selection button 216 by the user, a search may be performed (e.g, system 10 of FIG. 1 may perform the search in prescription card database 42 of FIG. 1) for pharmacies that provide the lowest total cost for each of prescription product A and prescription product B. As an example of performance of such a search, device 14 of FIG. 1 may search prescription card database 42 to find all of the pharmacies that sell both of the prescription products and that are located within a particular range of the user (e.g., such as within one mile, two miles, three miles, four miles, or any other range from the location of the user). The search may result in the generation of a list that includes pharmacy A (which may sell prescription product A for $2.00 and prescription product B for $2.00, for a total cost of $4.00), pharmacy B (which may sell prescription product A for $1.00 and prescription product B for $4.00, for a total cost of $5.00), and pharmacy C (which may sell prescription product A for $3.00 and prescription product B for $3.00, for a total cost of $6.00).

Following the selection of selection button 216 by a user (which, in particular embodiments, may be an example of selection 100 of FIG. 1), display 200c of FIG. 2C may be displayed to the user on mobile device 46. As illustrated, display 200c of FIG. 2C includes a potential pharmacy list 220, mapping 224, and guidance button 228. In particular embodiments, display 200c may be an example of results 112 of FIG. 1.

Potential pharmacy list 220 includes a list of potential pharmacies that has been generated as a result of the search. Potential pharmacy list 220 may include any number of pharmacies in the list. For example, potential pharmacy list 220 may include one pharmacy, two pharmacies, three pharmacies, four pharmacies, or any other suitable number of pharmacies. Furthermore, the pharmacies listed in potential pharmacy list 220 may be listed in any suitable order. As an example, the pharmacies listed in potential pharmacy list 220 may be ranked based on the total cost of the prescription products selected by the user. For example, potential pharmacy list 200 may list the pharmacy with the lowest total cost for the prescription product first. In such an example, pharmacy A (discussed above with a total cost of $4.00) may be listed first, pharmacy B (with a total cost of $5.00) may be listed second, and pharmacy C (with a total cost of $6.00) may be listed third. As such, the user may be able to view which pharmacy provides the lowest total cost for the prescription products selected for purchase by the user.

Map 224 may provide a mapping associated with the location of the user (e.g., from location indication 104) and a location of a selected pharmacy (e.g., pharmacy A). For example, mapping 224 may provide the distance and directions (in graphical form) from the location of the user to the location of the selected pharmacy. Mapping 224 may be provided in any suitable manner. As an example, prescription card application 50 may perform the mapping, or prescription card application 50 may provide the mapping from a different source (e.g., such as another application or website).

Guidance button 228 includes a button that the user may click on (or otherwise select) in order to receive real-time guidance instructions for how to get to the selected pharmacy. Following the selection by the user of guidance button 228, prescription card application 50 may provide real-time guidance to the user (e.g., by indicating via graphics and/or voice each street the user should travel on, each turn the user should make, etc.). On the other hand, following the selection by the user of guidance button 228, prescription card application 50 may transmit the user's current location and the location of the selected pharmacy to another application or website in order to provide the guidance.

Modifications, additions, or omissions may be made to displays 200 of FIGS. 2A-2C without departing from the scope of the disclosure. For example, although displays 200 are illustrated as including particular information, displays 200 may include more or less information.

FIGS. 3A-3B illustrate example displays 300 according to one embodiment of the present disclosure. Displays 300 may be displayed to a user using a mobile device, such as mobile device 46 of FIG. 1. Display 300a of FIG. 3A and display 300b of FIG. 3B may be displayed to a user following a selection by the user, such as a selection 100 of FIG. 1, associated with a search for a pharmacy. As an example, display 300a of FIG. 3A may be displayed to a user following the selection by the user on display 200a of FIG. 2A to search for a pharmacy based on information about the pharmacy (as is discussed above with regard to display 200a of FIG. 2A).

As illustrated, display 300a includes combination option 308, distance option 312, and discount option 316. Each of the options 308-316 may provide a different manner of searching for a pharmacy. As an example, distance option 312 may result in a search for pharmacies that are a close distance to the location of the user. In such an example, the search may locate pharmacy A as being one mile from the user, pharmacy B as being two miles from the user, and pharmacy C as being three miles from the user. As another example, discount option 316 may result in a search for pharmacies that provide the best overall discount when using a prescription card. An overall discount may refer to a discount that the pharmacy may provide on each of the prescription products sold by the pharmacy. For example, pharmacy A may offer a $2.00 discount (or a 10% discount) on all the prescription products it sells, pharmacy B may offer a $4.00 discount (or a 20% discount) on all the prescription products it sells, and pharmacy C may offer a $6.00 discount (or a 30% discount) on all the prescription products it sells. As a further example, combination option 308 may result in a search for pharmacies that are both (1) a close distance to the location of the user; and (2) provide the best overall discount when using a prescription card. The search provided by combination option 308 may weight each of the factors when generating a list of potential pharmacies. For example, both the first factor (e.g., the distance the pharmacy is located from the user) and the second factor (e.g., the overall discount offered by the pharmacy) may have equal weight when determining the potential pharmacies. Additionally, other weightings of the factors may be utilized. For example, the weighting ratio between the two factors may be 10:90, 20:80, 30:70, 40:60, 60:40, 70:30; 20:80, 90:10, or any other weighting ratio.

Following the selection of one of options 308-316 by a user (which, in particular embodiments, may be an example of selection 100 of FIG. 1), display 300b of FIG. 3B may be displayed to the user on mobile device 46. As illustrated, display 300b of FIG. 3b includes a potential pharmacy list 320, mapping 324, and guidance button 328.

Potential pharmacy list 320 includes a list of potential pharmacies that has been generated as a result of the search. Potential pharmacy list 320 may include any number of pharmacies in the list. For example, potential pharmacy list 320 may include one pharmacy, two pharmacies, three pharmacies, four pharmacies, or any other suitable number of pharmacies. Furthermore, the pharmacies listed in potential pharmacy list 320 may be listed in any suitable order. As an example, the pharmacies listed in potential pharmacy list 320 may be ranked based on the distance the pharmacy is to the location of the user, the overall discount provided by the pharmacy when using a prescription card, or a combination of both the distance the pharmacy is to the location of the user and the overall discount provided by the pharmacy when using a prescription card.

Map 324 may provide a mapping associated with the location of the user (e.g., from location indication 104) and a location of a selected pharmacy (e.g., pharmacy A). For example, mapping 324 may provide the distance and directions (in graphical form) from the location of the user to the location of the selected pharmacy. Mapping 324 may be provided in any suitable manner. As an example, prescription card application 50 may perform the mapping, or prescription card application 50 may provide the mapping from a different source (e.g., such as another application or website).

Guidance button 328 includes a button that the user may click on (or otherwise select) in order to receive real-time guidance instructions for how to get to the selected pharmacy. Following the selection by the user of guidance button 328, prescription card application 50 may provide real-time guidance to the user (e.g., by indicating via graphics and/or voice each street the user should travel on, each turn the user should make, etc.). On the other hand, following the selection by the user of guidance button 328, prescription card application 50 may transmit the user's current location and the location of the selected pharmacy to another application or website in order to provide the guidance.

Modifications, additions, or omissions may be made to displays 300 of FIGS. 3 A-3B without departing from the scope of the disclosure. For example, although displays 300 are illustrated as including particular information, displays 300 may include more or less information.

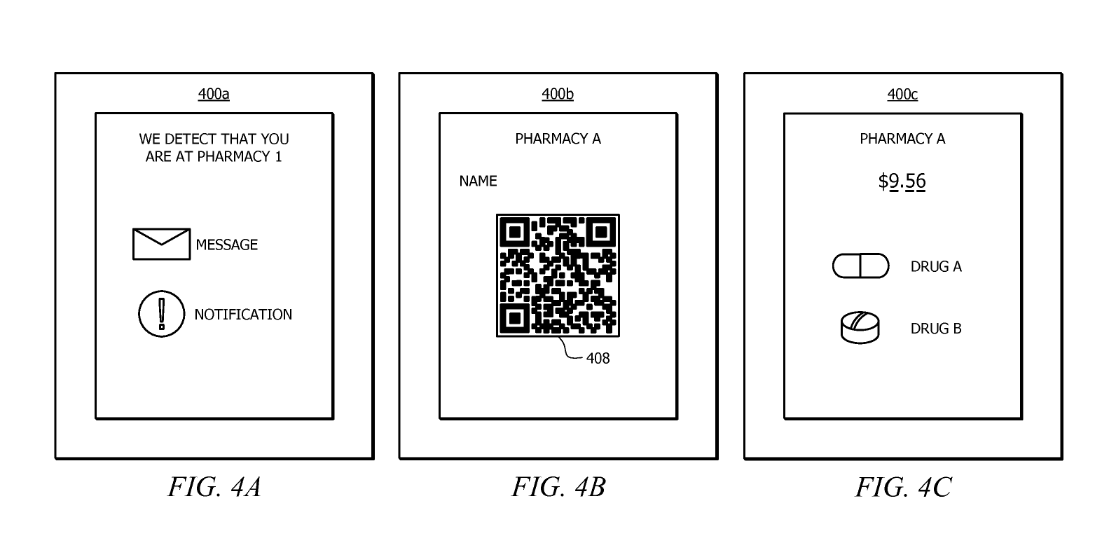

FIGS. 4A-4C illustrate example displays 400 according to one embodiment of the present disclosure. Displays 400 may be displayed to a user using a mobile device, such as mobile 46 of FIG. 1. Display 400a of FIG. 4A and display 400b of FIG. 4B may be displayed to a user following the transmission of a second location indication of the user, such as second location indication 116 of FIG. 1, and/or following the receipt of a code message, such as code message 120 of FIG. 1. Display 400c of FIG. 4C may be displayed to a user following the purchase of one or more prescription products by the user.

As described above, display 400a of FIG. 4A may be displayed to a user following the receipt of a second location indication 116 of the user. For example, prescription card application 50 may periodically send updates of the location of the user. Such updates may be transmitted automatically (e.g., without intervention by the user). Furthermore, receipt of the second location indication 116 by device 14 may allow device 14 to automatically (e.g., without intervention by the user) send code message 120 to the user when device 14 detects that the user is at a particular pharmacy.

As illustrated, display 400a includes notification 404. Notification 404 may refer to any indication that a user may click on (or otherwise select) in order to view information associated with the indication. For example, by clicking on notification 404, information included in code message 120 may be displayed to the user, such as in display 400b of FIG. 4B.

Display 400b includes code 408. Code 408 may refer to any code that is associated with the prescription card of the user. Code 408 may be any type of code that may be provided to the pharmacy when the user is purchasing prescription products. For example, code 408 may be in the form of a linear bar code (such as a universal product code (UPC) code), a matrix bar code (such as a quick response (QR) code), a sequence of numbers and/or symbols, any other code, or any combination of the preceding. Code 408 may be provided by the user to the pharmacy. For example, the display of code 408 on mobile device 46 may allow the pharmacy to scan code 408 or otherwise input code 408. As a result, code 408 may allow the user to receive the discount provided by the associated prescription card without requiring the user to actually have the prescription card on them when making the purchase.

Following the input of code 408 by the pharmacy and also following the purchase of one or more prescription products by the user using code 408, display 400c of FIG. 4C may be displayed to the user. Display 400c includes a summary of the purchase by the user. For example, display 400c may include a summary of the total discount received by the user when purchasing the prescription products, a list of the prescription products (such as an image and/or a description of the prescription products) purchased by the user, an identifier (such as a name and/or address) associated with the pharmacy from which the prescription products were purchased, any other suitable information associated with the purchase of prescription products, or any combination of the preceding. As such, the user may be able to view information associated with their purchase of prescription products.

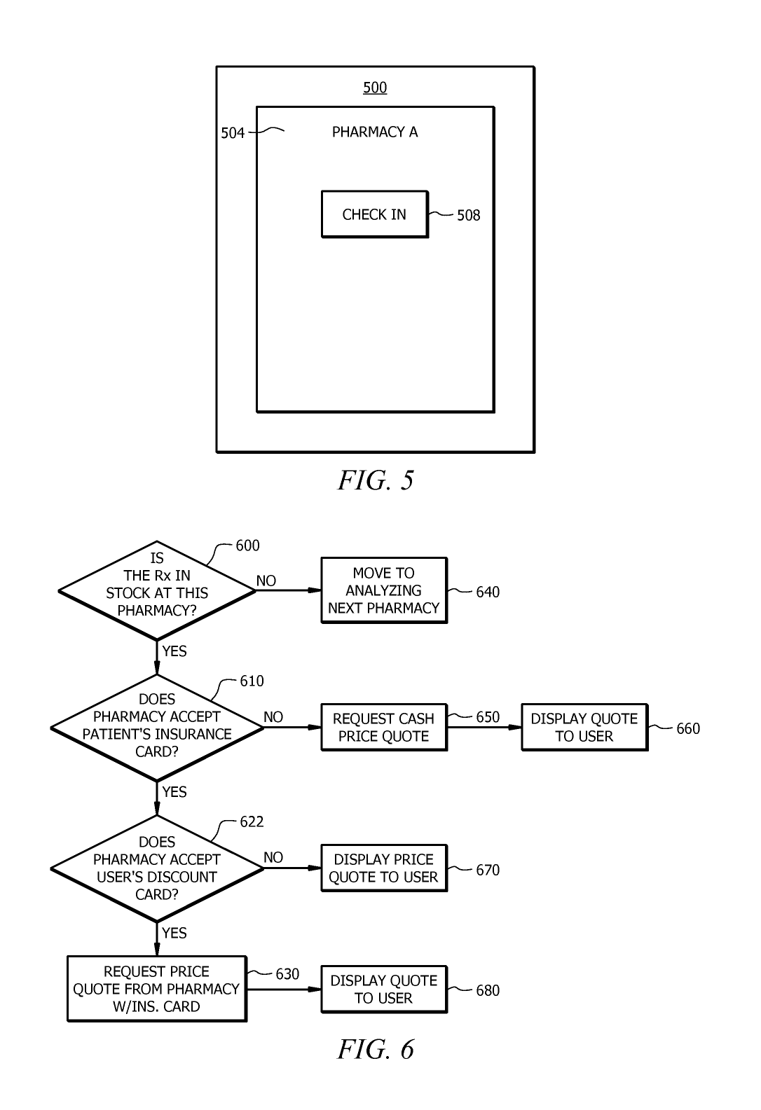

Although FIGS. 4A-4C have been described above as communicating code 408 for display to a user automatically (e.g, without intervention from the user), in particular embodiments, code 408 may be communicated for display to the user after receiving a selection associated with the user checking into one of the potential pharmacies. For example, as is illustrated in FIG. 5, following a determination by device 14 that the user is located at a particular pharmacy, device 14 may communicate display 500 for display to the user. As illustrated, display 500 includes an identifier 504 and a check-in button 508. Identifier 504 includes any identifier of a pharmacy in which the user is detected as being located. For example, identifier 504 may include a name of a pharmacy, a location of the pharmacy, a graphic associated with the pharmacy, any other identifier associated with the pharmacy, or any combination of the preceding. Check-in button 508 includes any button that may be clicked on (or otherwise selected) in order for a user to check into a particular pharmacy. For example, when the user is located in pharmacy A, the user may click on check-in button 508 in order to check into pharmacy A with device 14. As a result, device 14 may communicate code message 120 (which may include code 408) to mobile device 46 for display to the user, as is described above with regard to FIGS. 4B-4C.

Modifications, additions, or omissions may be made to displays 400 of FIGS. 4A-4C and/or display 500 of FIG. 5 without departing from the scope of the disclosure. For example, although displays 400 and 500 are illustrated as including particular information, displays 400 and 500 may include more or less information.

While some embodiments described above focus on consumer facing functionality, the system can also provide an interface for doctors and/or pharmacies and other service providers. Such service providers can communicate with patients, refill prescriptions and perform other functions. The invention can provide a medical history for a patient that is easy to access, for both the patient and for service providers.

Most interactions with the invention will be of a typical variety involving the internet, with parties connecting by TCP/IP or other similar methods. Users and providers can access the system via the internet, or a dedicated application on a tablet or Smartphone, or a variety of other ways.

FIG. 6 displays a flow chart of one embodiment of the invention. FIG. 6 shows the process carried out when a consumer is looking for a prescription medication and is checking prices at various pharmacies. The steps of FIG. 6 can be carried out by the device 14 or mobile device 46 of FIG. 1. If the steps are carried out by the device 14 then it will communicate the results to the mobile device 46 and send commands such as when to display information to a user. As shown in FIG. 6, the process can involve asking a pharmacy if a medicine is in stock, whether they accept the patient's insurance and discount cards and returning a price quote to a user. The invention can provide the user with a list of quotes from various pharmacies.

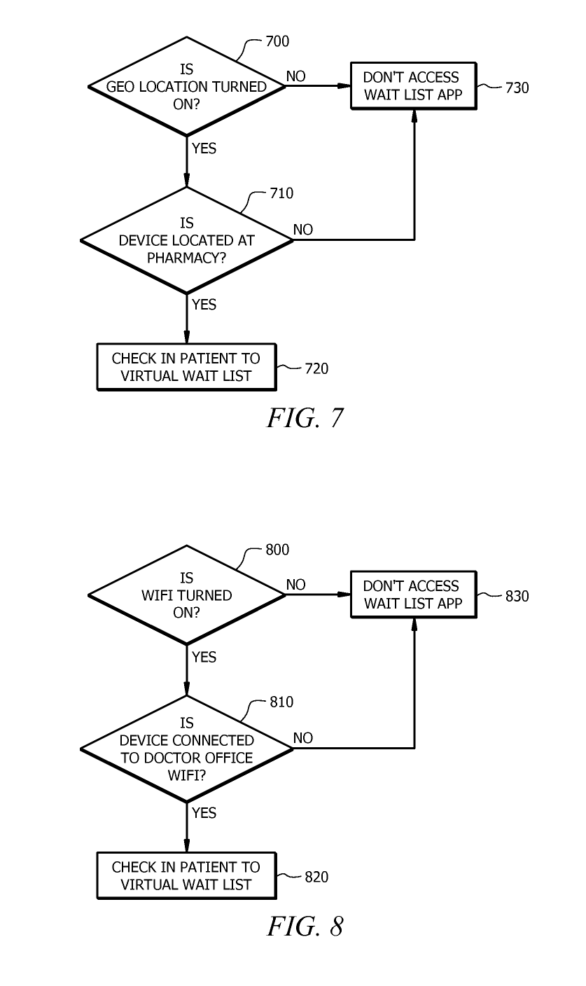

FIG. 7 displays a flow chart for an automatic check-in function. The invention is capable of checking customers in to a virtual or real waiting line at a doctor's office or pharmacy. The functionality can use geo-location accessible within a mobile device to ascertain its location. If a patient is located within a known doctor's office or known pharmacy then the mobile device can launch an application for to allow the user to check-in, or the mobile device can perform an automatic check-in.

FIG. 8 shows another flow chart of an embodiment for automatic check-in. In this embodiment the mobile device senses when it's connected to a Wi-Fi network it knows is at a doctor's office or pharmacy, and begins the check-in process as a result.

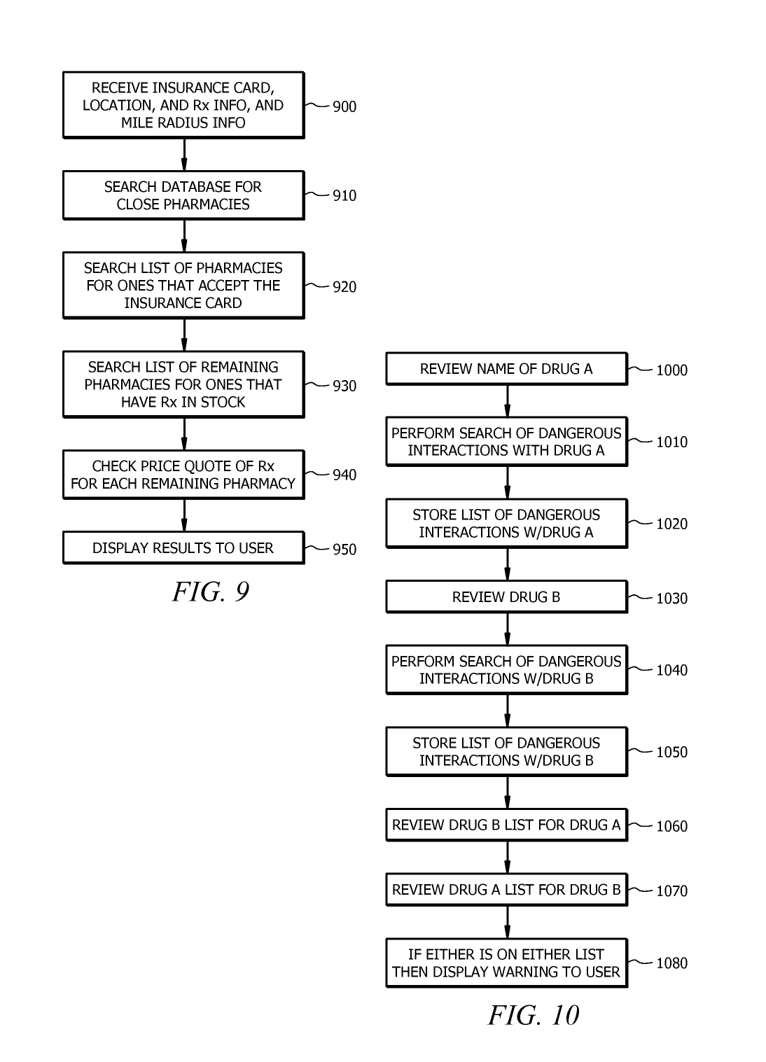

FIG. 9 shows a flow chart of an embodiment wherein the user searches for pharmacies in close proximity and checks the availability of a given medicine and gives the user a price quote. The process begins by searching for pharmacies within a given distance, then culling that list by checking for pharmacies that accept the user's insurance. Then that list is reviewed for which pharmacies have a prescription in stock and then a price quote from each of the remaining pharmacies is shown to the user.

FIG. 10 shows a flow chart of an embodiment of the drug interaction aspect of the invention. The invention can search for dangerous drug interactions for each prescription that a user has. The invention can then store a list of the possibly dangerous drugs and compare it to the drugs that the user is taking. The mobile device, or other device, can then issue a warning to the user.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for interconnecting a pharmacy and a user's mobile device, comprising:
a memory;
one or more processors communicatively coupled to the memory and operable to:
receive, from the user, a selection associated with a search for a pharmacy;
receive an indication of a location of the user from the mobile device associated with the user;
based at least on the selection and the indication of the location, generate a list of a plurality of potential pharmacies that are each associated with a prescription card of the user; and
communicate, for display to the user, the list, using the mobile device.

2. The system of claim 1, wherein:
the selection comprises a selection of a plurality of prescription products; and each of the plurality of potential pharmacies are ranked in the list based on a total cost of the plurality of prescription products at the respective potential pharmacy.

3. The system of claim 1, wherein:
the selection comprises a selection of a combination of distance and overall discount; and
each of the plurality of potential pharmacies are ranked in the list based on a combination of:
a distance of the respective potential pharmacy from the location of the user; and
an overall discount offered by the respective potential pharmacy as a result of the prescription card.

4. The system of claim 1, wherein the one or more processors are further operable to:
receive an indication of a second location of the user;
based at least on the indication of the second location, determine that the user is currently located at one of the potential pharmacies; and
automatically, without intervention from the user, communicate, for display to the user, a graphical user interface that includes a code associated with the prescription card.

5. The system of claim 1, wherein the one or more processors are further operable to:
receive an indication of a second location of the user;
based at least on the indication of the second location, determine that the user is currently located at one of the potential pharmacies;
receive, from the user, a selection associated with checking-in to the one of the potential pharmacies; and
following reception of the selection associated with checking-in to the one of the potential pharmacies, communicate, for display to the user, a graphical user interface that includes a code associated with the prescription card.

6. The system of claim 1, wherein the one or more processors are further operable to generate a list of potential pharmacies that are each associated with a second prescription card of the user.

7. The system of claim 1, wherein the one or more processors are further operable to generate a list of dangerous drug interactions related to the selection.

8. The system of claim 1, wherein the list comprises a map.

9. The system of claim 1, wherein the list comprises an option for directions to a location.

10. A system for communicating pharmacy and insurance information to mobile device of a user, comprising:
a network connection;
a microprocessor;
a memory:
a database, the database operable to:
store location information regarding at least one pharmacy and insurance information regarding at least one user;
communicate the insurance information to the at least one pharmacy;
receive availability and price information from the at least one pharmacy;
communicate the location information, availability information and price information for display to the user.

11. The system of claim 10, wherein the database is further operable to communicate a ranking of a plurality of pharmacies based on location, availability and price information to a mobile device.

12. The system of claim 10, wherein the database is operable to create a list of a plurality of potential pharmacies, the plurality of potential pharmacies ranked on a combination of:
a distance of the respective potential pharmacy from the location of the user; and
an overall discount offered by the respective potential pharmacy as a result of the prescription card.

13. The system of claim 10, wherein the database is further operable to:
receive an indication of a location of the user;
based at least on the indication of the location, determine that the user is currently located at a potential pharmacy; and
automatically, without intervention from the user, communicate, for display to the user, a graphical user interface that includes a code associated with the prescription card.

14. The system of claim 10, wherein the database is further operable to:
receive an indication of a location of the user;
based at least on the indication of the location, determine that the user is currently located at a potential pharmacy;
receive, from the user, a selection associated with checking-in to the potential pharmacy; and
following reception of the selection associated with checking-in to the potential pharmacy, communicate, for display to the user, a graphical user interface that includes a code associated with the prescription card.

15. The system of claim 10, wherein the database is further operable to generate a list of potential pharmacies that are each associated with second insurance information of a user.

16. The system of claim 10, wherein the database is further operable to receive a search selection related to a medicine and to generate a list of dangerous drug interactions for the medicine for display to the user.

17. The system of claim 10, wherein the location information comprises a map.

18. The system of claim 10, wherein the location information comprises an option for directions to a location.

19. A method for interconnecting a pharmacy and a user of a mobile device, comprising:
storing pharmacy related data on one or more databases;
receiving from the user a selection associated with a search for a pharmacy;
receiving an indication of the location of the user;
generating a list, based at least on the selection and the indication of the location, of a plurality of potential pharmacies that are each associated with a prescription card of the user; and
communicating, for display to the user, the list, on the mobile device.

20. The method of claim 19, wherein the selection is a name of a drug.

21. The method of claim 19, wherein the selection is a pharmacy name.

22. The method of claim 19, wherein the list comprises a map.

23. The method of claim 19, wherein the indication of the location of a user is received from the mobile device.

24. The method of claim 19, wherein the mobile device is a smartphone.
